(19) United States
(12) Patent Application Publication
(10) Pub. No.: US 2015/0030816 A1
(43) Pub. Date: Jan. 29, 2015

(54) REINFORCED GLASS ARTICLE AND TOUCH SENSOR INTEGRATED-TYPE COVER GLASS

(71) Applicant: ASAHI GLASS COMPANY, LIMITED, Tokyo (JP)

(72) Inventors: Naoki UEMURA, Tokyo (JP); Masao Ozeki, Tokyo (JP); Kiyoshi Tamai, Tokyo (JP); Noriko Kishikawa, Tokyo (JP)

(73) Assignee: ASAHI GLASS COMPANY, LIMITED, Tokyo (JP)

(21) Appl. No.: 14/511,957

(22) Filed: Oct. 10, 2014

Related U.S. Application Data
(63) Continuation of application No. PCT/JP2013/060380, filed on Apr. 4, 2013.

(30) Foreign Application Priority Data
Apr. 10, 2012 (JP) 2012-089040

(51) Int. Cl. C03C 21/00; C03B 33/02; C03C 17/32; G06F 3/041; C03C 15/02

(52) U.S. Cl. CPC C03C 21/00; G06F 3/0412; C03C 15/02; C03C 17/32; C03B 33/02
USPC 428/192

(57) ABSTRACT

The present invention provides a strengthened glass article, containing a glass sheet having: a first main surface; a second main surface that is opposite to the first main surface; and an end surface that connects the first main surface and the second main surface, in which the glass sheet is a strengthened glass sheet which comprises a compressive stress layer on each surface of the first main surface and the second main surface and a tensile stress layer on the end surface, in which the end surface of the strengthened glass sheet has an arithmetic average roughness Ra, satisfying Ra≦3 μm, and the end surface is provided with a protective layer, and in which the protective layer has a maximum thickness T₁ and the strengthened glass sheet has a thickness T₀, satisfying 50 μm<T₁≦2T₀.

### CROSS-REFERENCE TO RELATED APPLICATIONS

This application is a continuation of prior International Application No. PCT/JP2013/060380 filed on Apr. 4, 2013, which is based upon and claims the benefit of priority from Japanese Patent Application No. 2012-089040 filed on Apr. 10, 2012; the entire contents of all of which are incorporated herein by reference.

### TECHNICAL FIELD

The present invention relates to a strengthened glass article, and touch sensor integrated-type cover glass.

### BACKGROUND ART

An electrostatic capacitance type touch panel, which is used in portable terminals such as a smartphone and a tablet computer, generally has a configuration in which a light-transmitting input position-detecting electrode and the like are formed on a glass substrate and thereon is placed a cover glass made of a strengthened glass sheet.

On the other hand, in order to realize a reduction in the number of parts and a reduction in thickness of electrostatic capacitance type touch panels, JP-A No. 2011-197708 (KOKAI) discloses an electrostatic capacitance type touch panel having a configuration in which the cover glass is directly provided with the input position-detecting electrode and the like, whereby the glass substrate is no longer necessary.

As a method of manufacturing the cover glass (also referred to as a touch sensor integrated-type cover glass) of JP-A No. 2011-197708 (KOKAI), the following method is preferable in consideration of productivity. The method includes subjecting a large-sized raw glass sheet capable of obtaining a plurality of sheets of cover glass having a product size to a film forming treatment, a patterning treatment, and the like to form an input position-detecting electrode and the like for the each product size, and then cutting the raw glass sheet for the each product size to obtain the cover glass.

However, there has been a problem that when a strengthened glass sheet is used as the raw glass sheet, a tensile stress layer is exposed on a surface layer of an end surface of the strengthened glass sheet that is cut, whereby the strengthened glass sheet is easily broken due to flaws generated on the end surface as start points.

That is, since the strengthened glass sheet has compressive stress layers on front and rear main surfaces thereof and a tensile stress layer thereinside, it is initially difficult to cut the strengthened glass sheet with a good quality. For example, in the case of a method of applying a marking line (a groove line) to the main surface of the glass sheet by a wheel cutter along a planned cutting line and then performing cutting, that is, a so-called wheel-cutting method, there is a problem in terms of strength in some cases since the strengthened glass sheet has a lot of and rough cut flaws.

Accordingly, in order to enhance the strength of an end surface of the strengthened glass sheet on which a tensile stress layer is exposed, it is effective to polish the end surface of the strengthened glass sheet so as to remove flaws that become a possible cause of breakage and to make the end surface have a predetermined roughness or less.

JP-A No. 2010-269389 (KOKAI) discloses a polishing apparatus that polishes an end surface of a glass sheet by pressing a rotary polishing brush against the end surface.

In addition, in the case of a cutting method in which the end surface immediately after the cutting has a small roughness and thus becomes an approximately mirrored surface, chamfering or polishing of the end surface may be omitted in some cases. The cutting method in which the end surface becomes a mirrored surface includes a method of performing cutting using a CO₂ laser and the like.

### SUMMARY OF THE INVENTION

When the end surface of the strengthened glass sheet comes into contact with other components during transportation, handling or like of the strengthened glass sheet, flaws are generated on the end surface, whereby the strengthened glass sheet may be broken in some cases.

That is, the tensile stress layer is exposed on the end surface of the strengthened glass sheet. Therefore, even when the end surface is polished, in a case where flaws are generated on the end surface, the strength easily decreases.

The invention has been made in consideration of the above-described circumstances, and an object of the invention is to provide a strengthened glass article and a touch sensor integrated-type cover glass having an enhanced edge strength in a strengthened glass sheet in which a tensile stress layer is exposed on an end surface.

In order to attain the above-mentioned object, the invention provides a strengthened glass article, containing a glass sheet having:

a first main surface;

a second main surface that is opposite to the first main surface; and

an end surface that connects the first main surface and the second main surface,

in which the glass sheet is a strengthened glass sheet which comprises a compressive stress layer on each surface of the first main surface and the second main surface and a tensile stress layer on the end surface,

in which the end surface of the strengthened glass sheet has an arithmetic average roughness Ra, satisfying Ra≦3 μm, and the end surface is provided with a protective layer, and

in which the protective layer has a maximum thickness T₁ and the strengthened glass sheet has a thickness T₀, satisfying 50 μm<T₁≦2T₀.

The glass sheet of the strengthened glass article according to the invention is intended for a strengthened glass sheet which is cut after being strengthened. In the strengthened glass sheet that is cut after being strengthened, a tensile stress layer is exposed on the end surface thereof.

In the strengthened glass sheet of the invention, as a first step, an arithmetic average roughness Ra of the end surface is set to 3 μm or less, thereby enhancing the strength (bending strength) of the end surface itself of the strengthened glass sheet. In addition, as a second step, a protective layer is provided to the end surface in which the edge strength is enhanced. Accordingly, the end surface of the strengthened glass sheet is protected by the protective layer, whereby a decrease in the edge strength due to contact with other components is suppressed. As a result, according to the invention, it is possible to provide a strengthened glass article having an enhanced edge strength in a strengthened glass sheet in which a tensile stress layer is exposed on the end surface thereof.

In addition, the strength of the end surface itself of the strengthened glass sheet is enhanced by setting Ra to be 3 μm or less. It cannot be said that the strength of the end surface itself of the strengthened glass sheet is enhanced due to the protective layer being provided thereto, but a decrease in strength after abrasion can be suppressed by making a glass article provided with the protective layer. A state in which a decrease in edge strength of a glass article after abrasion (hereinafter, referred to as abraded edge strength) is suppressed is described as “abraded edge strength is enhanced” in the present specification.

In an abrasion durability test of the protective layer which is performed under predetermined conditions, when the maximum thickness T₁ of the protective layer is 50 μm or less, sufficient durability cannot be obtained because the thickness of the protective layer is small. On the other hand, when the T₁ exceeds 2T₀, dimensional accuracy of the strengthened glass sheet including the protective layer decreases, and thus this range is not preferable. In addition, during handling of the strengthened glass sheet, a bending moment that occurs at a boundary portion between the end surface of the strengthened glass sheet and the protective layer increases, whereby the protective layer tends to be detached from the end surface.

From the viewpoint of compatibility between securing durability of the protective layer and prevention of detachment of the protective layer, the T₁ more preferably satisfies 50 μm<T₁≦1.5 T₀ and still more preferably satisfies 50 μm<T₁≦T₀.

In addition, in the case where the thickness T₀ of the strengthened glass sheet satisfies 0.5 mm≦T₀≦1.1 mm, the maximum thickness T₁ of the protective layer satisfies 50 μm<T₁≦2200 μm. However, in consideration of application efficiency of the protective layer, the maximum thickness T₁ of the protective layer is preferably set to 300 μm to 1000 μm and is more preferably set to 400 μm to 600 μm.

In addition, in the case where the end surface of the strengthened glass sheet after chamfering is subjected to an etching treatment, the arithmetic average roughness Ra of the end surface can be set to 3 μm or less. That is, a leading end of a flaw on the end surface of the strengthened glass sheet is etched by the etching treatment, and thereby becoming rounded in an arc shape. In the etching treatment, it is preferable that an etched amount (etching removal) of the end surface of the strengthened glass sheet is approximately 5 μm.

WO2010/135614 discloses a technique of coating an end surface of a glass sheet. However, the glass sheet intended for the technique is not the strengthened glass sheet that is cut after being strengthened. Accordingly, WO2010/135614 does not disclose the technical idea of enhancing the edge strength of the strengthened glass sheet, which is cut after being strengthened, in separate two steps.

In the strengthened glass article according to the invention, the end surface of the strengthened glass sheet preferably has the arithmetic average roughness Ra, satisfying Ra≦20 nm.

When the end surface of the strengthened glass sheet after being cut is polished by bringing the end surface into contact with a rotary brush while supplying a polishing solution that contains a polishing agent, it is possible to obtain an arithmetic average roughness Ra of 20 nm or less.

In the strengthened glass article according to the invention, it is preferable that the protective layer has a thickness T₂ at a boundary position between the compressive stress layer and the tensile stress layer of the strengthened glass sheet, satisfying T₂≧30 μm.

In the abrasion durability test, the depth of flaws generated in a thickness direction of the protective layer did not reach 30 μm even in the deepest one. Therefore, when the thickness T₂ is set to 30 μm or more, it is possible to prevent the flaws from reaching the end surface of the strengthened glass sheet, thereby maintaining durability.

In the strengthened glass article according to the invention, it is preferable that the protective layer includes an extending portion extending to at least one main surface of the first main surface and the second main surface.

When the extending portion is provided to the protective layer, it is possible to further enhance the abraded edge strength of the edge (a corner portion at a boundary between the first main surface and the end surface and a corner portion at a boundary between the second main surface and the end surface) of the strengthened glass sheet.

In the strengthened glass article according to the invention, in the case where the strengthened glass sheet is a strengthened glass sheet that is used in touch sensor integrated-type cover glass, it is preferable that the extending portion is not extended to a main surface that is a touch surface. The reason is that the extending portion is exposed to the outside, whereby the external appearance of the touch sensor integrated-type cover glass becomes deteriorated.

In addition, it is preferable that the extending portion has a length X, that is, the length X from a boundary of the end surface and the main surface of the strengthened glass sheet to an in-plane portion of the main surface, satisfying 10 μm≦X≦200 μm.

When a value of the length X is 10 μm or more, it is possible to prevent the abraded edge strength from decreasing, and adhesion between the strengthened glass sheet and the protective layer is enhanced due to an increase in the contact area therebetween. In addition, when X is 200 μm or less, deterioration of the external appearance is not caused, and the extending portion does not hinder the application of a protective film for prevention of scattering glass pieces during crushing in a subsequent process.

Moreover, it is preferable that the extending portion has a thickness Y, that is, the thickness Y in a direction perpendicular to the main surface of the strengthened glass sheet, satisfying 10 μm≦Y≦100 μm.

According to the invention, the abraded edge strength against a force applied from an inclined direction with respect to a direction perpendicular to the end surface is improved.

When a value of the thickness Y is 10 μm or more, it is possible to prevent the abraded edge strength from decreasing. In addition, when the Y is 100 μm or less, deterioration of the external appearance is not caused, and the extending portion does not hinder the application of the protective film in a subsequent process.

In the strengthened glass article according to the invention, it is preferable that the protective layer is a photo-cured resin or a heat-cured resin.

In the strengthened glass article according to the invention, it is preferable that the protective layer is an ultraviolet-cured resin.

Moreover, in order to attain the above-mentioned object, the present invention also provides a touch sensor integrated-type cover glass, containing the above-mentioned strengthened glass article.

The strengthened glass sheet stated in the present specification is a glass sheet in which compressive stress layers are formed on the first main surface and the second main surface on front and rear sides, and a tensile stress layer is formed inside of the glass sheet in a thickness direction for balancing stress. As a method of manufacturing the strengthened glass sheet, there are known a cold air strengthening method that is a physical strengthening method using expansion and contraction of glass due to heating and cooling, and a chemical strengthening method in which alkali ions in glass are exchanged with other alkali ions having a larger ionic radius. Since the touch sensor integrated-type cover glass has a thickness as small as 0.5 mm to 1.1 mm, the latter chemical strengthening method is applied.

According to the strengthened glass article and the touch sensor integrated-type cover glass of the present invention, it is possible to provide a strengthened glass article having an enhanced edge strength in a strengthened glass sheet in which a tensile stress layer is exposed on an end surface thereof.

### BRIEF DESCRIPTION OF THE DRAWINGS

A more complete appreciation of the invention and many of the attendant advantages thereof will be readily obtained as the same becomes better understood by reference to the following the detailed description when considered in connection with the accompanying drawings.

FIG. 1 is a cross-sectional view schematically illustrating a configuration of a sensor integrated-type cover glass.

FIG. 2 is a flowchart illustrating an example of a process of manufacturing a sensor integrated-type cover glass.

FIGS. 3A and 3B are cross-sectional views of an end surface, which schematically illustrate roughness of the end surface immediately after cutting and roughness of the end surface after an etching treatment, respectively.

FIG. 4 is a side view of a brush polishing apparatus that polishes an end surface of a glass sheet.

FIGS. 5A and 5B are cross-sectional views of an end surface, which schematically illustrate roughness of the end surface immediately after cutting and roughness of the end surface after a polishing treatment.

FIGS. 6A to 6C are explanatory views illustrating a process of applying a protective layer to an end surface of a glass sheet.

FIG. 7 is an enlarged cross-sectional view of an end surface and a protective layer, which illustrates an example of a cross-sectional shape of the protective layer.

### DETAILED DESCRIPTION

The invention will now be described with reference to embodiments and the accompanying drawings, wherein like reference numerals designate corresponding or identical elements throughout the various drawings.

### Embodiment

Hereinafter, a preferred embodiment of the strengthened glass article and the touch sensor integrated-type cover glass of the invention will be described in detail with reference to the attached drawings.

Here, as the strengthened glass article of the embodiment, a cover glass that constitutes an input operation surface of an electrostatic capacitance type touch panel of portable terminals such as a smartphone, a tablet computer and the like, particularly, a touch sensor integrated-type cover glass is exemplified.

### (Configuration of Touch Sensor Integrated-Type Cover Glass)

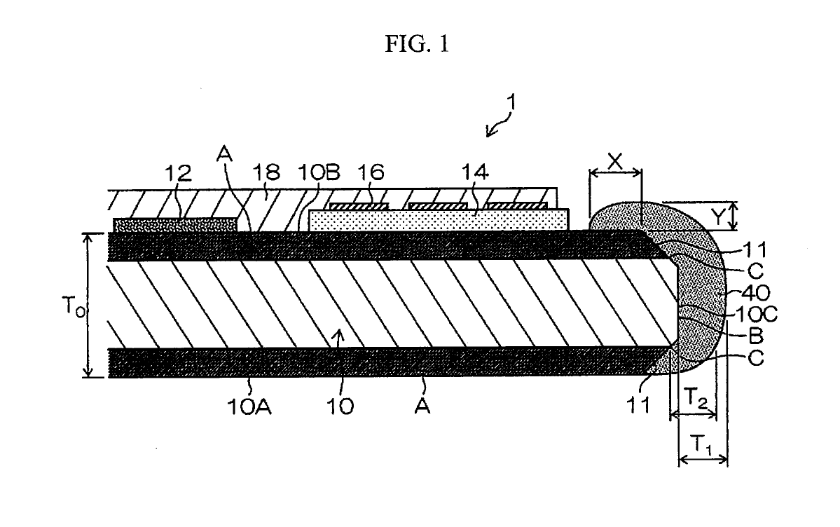

FIG. 1 is an enlarged cross-sectional view of main parts, which schematically illustrates a configuration of the touch sensor integrated-type cover glass 1.

The touch sensor integrated-type cover glass 1 constitutes an input operation surface of an electrostatic capacitance type touch panel, and has a function as a cover glass that protects a display and a function as a sensor substrate on which an input position-detecting electrode and the like are formed.

The touch sensor integrated-type cover glass 1 contains a glass sheet 10 having a first main surface 10A that is an input operation surface, a second main surface 10B that is opposite to the first main surface 10A, and an end surface 10C that connects the first main surface 10A and the second main surface 10B. The glass sheet 10 is a strengthened glass sheet. A compressive stress layer A is provided on each surface layer of the first main surface 10A and the second main surface 10B, and a tensile stress layer B is exposed on the end surface 10C. In addition, a protective layer 40, which protects the end surface 10C, is provided on the end surface 10C. The protective layer 40 will be described later.

An input position-detecting electrode 12, a light-shielding layer 14 which is black-colored, a peripheral interconnection 16, a protective film 18, and the like, which constitute a touch sensor, are provided on the second main surface 10B of the glass sheet 10.

The glass sheet 10 is a strengthened glass sheet. Typically, the thickness of the glass sheet 10 is approximately 0.3 mm to 1.5 mm, and preferably 0.5 mm to 1.1 mm. The glass sheet 10 having such a small plate thickness is a strengthened glass sheet that is strengthened by a chemical strengthening method. In addition, in the glass sheet 10, the end surface 10C is chamfered as necessary. That is, a corner portion at a boundary portion between the first main surface 10A and the end surface 10C and a corner portion at a boundary portion between the second main surface 10B and the end surface 10C are ground, whereby chamfered surfaces 11 having a predetermined width are formed. The chamfered surface 11 may be formed by a so-called C-chamfering or R-chamfering.

The input position-detecting electrode 12 is formed in a central region (an effective pixel region of a displaying means such as a liquid crystal display panel) of the second main surface 10B of the glass sheet 10 by using a light-transmitting conductive film such as an ITO (indium tin oxide) film. The thickness of the light-transmitting conductive film that constitutes the input position-detecting electrode 12 is approximately 20 nm to 100 nm.

The light-shielding layer 14 is formed to cover portions outside of a display area of the display panel, and is formed in a region at the periphery of the central region in which the input position-detecting electrode 12 is formed, that is, in a peripheral region. The light-shielding layer 14 is, for example, constructed of a black photo-sensitive resin (photoresist) that contains titanium black and the like. The thickness of the light-shielding layer 14 is approximately 1 μm to 2 μm. In addition, the light-shielding layer 14 may be formed by a screen printing method and the like. However, in the case of using the printing method, the thickness of the light-shielding layer 14 becomes as large as approximately 10 μm to 30 μm, whereby it is preferable to use the photoresist as the light-shielding layer 14.

The peripheral interconnection 16 is formed on the light-shielding layer 14 and is constructed, for example, of a film composed of a metal such as Mo—Nb alloy/Al/Mo—Nb alloy and Mo—Nb alloy/Al—Nd alloy/Mo—Nb alloy. The thickness of the metal film that constitutes the peripheral interconnection 16 is approximately 0.3 μm to 0.5 μm.

The protective film 18 is formed to cover the input position-detecting electrode 12, the light-shielding layer 14, and the peripheral interconnection 16, for the purpose of primarily protecting the input position-detecting electrode 12, the light-shielding layer 14, and the peripheral interconnection 16. For example, the protective film 18 is formed by a light-transmitting photoresist. The thickness of the protective film 18 is approximately 1 μm to 2 μm.

### (Method of Manufacturing Touch Sensor Integrated-Type Cover Glass)

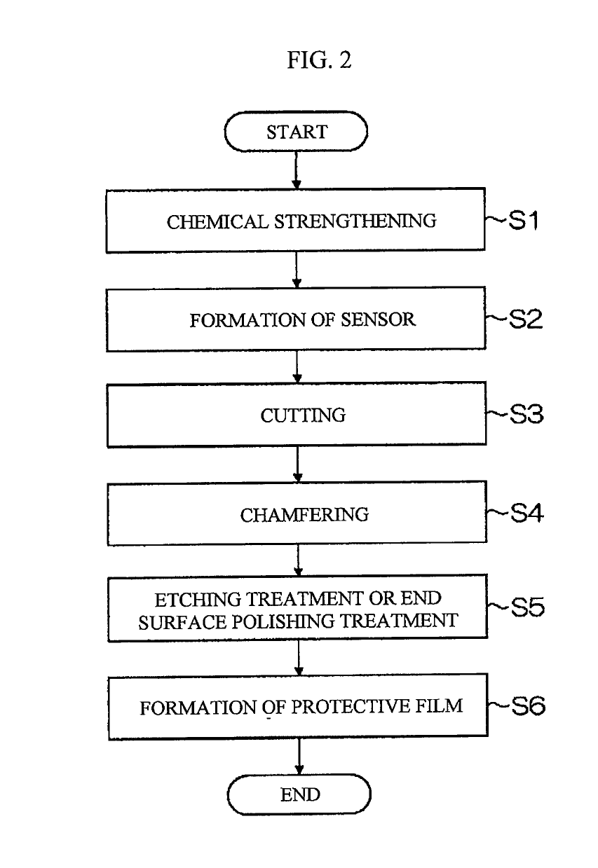

FIG. 2 is a flowchart illustrating an example of a process of manufacturing the touch sensor integrated-type cover glass 1.

The touch sensor integrated-type cover glass 1 is manufactured by forming the input position-detecting electrode and the like on a raw glass sheet (a large-sized glass sheet) capable of obtaining a plurality of glass sheets 10 having a product size, followed by cutting the raw glass sheet into the glass sheet 10 having the product size.

In this case, the strengthened glass sheet is used as the raw glass sheet: As a method of manufacturing the strengthened glass sheet, there are known a cold air strengthening method that is a physical strengthening method using expansion and contraction of glass due to heating and cooling, and a chemical strengthening method in which alkali ions in glass are exchanged with other alkali ions having a larger ionic radius. However, as described above, the chemical strengthening method is applied to a cover glass having a small thickness.

When manufacturing the touch sensor integrated-type cover glass 1, first, as shown in FIG. 2, a treatment of chemically strengthening a non-strengthened raw glass sheet is performed (step S1).

Next, the input position-detecting electrode 12, the light-shielding layer 14, the peripheral interconnection 16, the protective film 18, and the like are formed on the second main surface 10B of the raw glass sheet, and sensors are mounted on the raw glass sheet by each product unit (step S2). Since a method of mounting the sensors is a known technique, a detailed description thereof will be omitted.

Next, the raw glass sheet is cut into the glass sheet 10 having a product size, thereby obtaining a plurality of glass sheets 10 (step S3). The cutting of the raw glass sheet is performed by, for example, a wheel cutting method, a laser cutting method or the like.

The laser cutting method is a method of irradiating a main surface of the raw glass sheet with laser light along a planned cutting line, and cutting the raw glass sheet. As a heat source, a discharging electrode may be used instead of a laser light source.

In addition, during cutting, each glass sheet 10 is cut to have the same size.

After the cutting, the end surface 10C of the glass sheet 10 is chamfered (step S4). For example, the chamfering is performed by bringing a rotary grindstone into contact with the end surface 10C of the glass sheet 10 to grind and remove a corner portion at a boundary between the first main surface 10A and the end surface 10C and a corner portion at a boundary between the second main surface 10B and the end surface 10C of the glass sheet 10. However, the chamfering may be performed by other methods.

Here, the end surface 10C of the glass sheet 10 represents a cut-out surface obtained by cutting the raw glass sheet. In the case of performing the chamfering after the cutting, the end surface 10C is intended to include a chamfered surface 11.

In addition, the process of chamfering is a process that is selectively performed. That is, it is not necessary to perform the chamfering after the cutting, and the chamfering is a process that is selectively performed as necessary. However, when the chamfering is performed, there is an advantage in that it is possible to effectively prevent cracking in edge portions (a corner portion at a boundary between the first main surface 10A and the end surface 10C and a corner portion at a boundary between the second main surface 10B and the end surface 10C of the glass sheet 10) of the glass sheet 10.

As described above, the glass sheet 10, which is a strengthened glass sheet, is obtained by cutting the chemically strengthened raw glass sheet. In this manner, in the glass sheet 10 that is cut after strengthening, the tensile stress layer B is exposed on the end surface 10C. In addition, flaws that become a cause of breakage are present on the end surface 10C on which the tensile stress layer B is exposed, whereby the glass sheet 10 may be easily broken due to the flaws as start points.

In the embodiment, an etching treatment or a polishing treatment is performed on the end surface 10C of the glass sheet 10 (step S5) to prevent the breakage of the glass sheet 10, that is, to enhance the edge strength of the end surface 10C of the glass sheet 10.

When the etching treatment is performed on the end surface 10C, the sharp tip portion of concavo-convex portions of the flaws that become a cause of cracking of the glass sheet 10 can be made to have an obtuse angle. In addition, when the polishing treatment is performed with respect to the end surface 10C, it is possible to remove the flaws, whereby the edge strength of the glass sheet 10 is enhanced.

### (Etching Treatment)

As an example, the end surface 10C of the glass sheet 10 is immersed in a mixed aqueous solution that contains 2 wt % of HF in 6 mol/L of HCl to dissolve the end surface 10C to a depth of 5 μm from the surface.

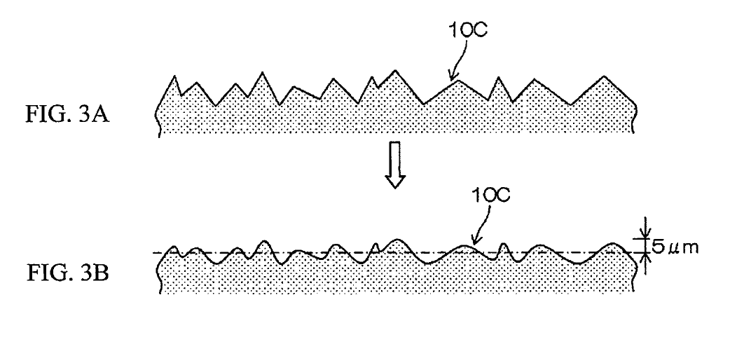

FIG. 3A is a cross-sectional view of the end surface 10C, which schematically illustrates roughness (shape) of the end surface 10C immediately after cutting. FIG. 3B is a cross-sectional view of the end surface 10C, which schematically illustrates the roughness (shape) of the end surface 10C after the etching treatment.

As shown in FIGS. 3A and 3B, among the concavo-convex portions of the flaws on the end surface 10C of the glass sheet 10, a sharp bottom portion of a concave portion and a sharp tip portion of a convex portion are dissolved to have an obtuse angle in an arc shape, and the arithmetic average roughness Ra of the end surface 10C becomes 3 μm or less, whereby the edge strength is enhanced. In addition, it is preferable that an etched amount (etching removal) of the end surface 10C in the etching treatment is approximately 5 μm.

### (Polishing Treatment)

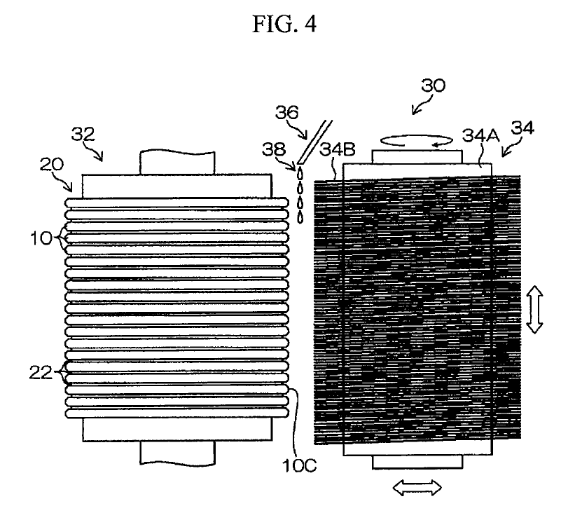

FIG. 4 is a side view of a brush polishing apparatus 30 that polishes the end surface 10C of the glass sheet 10.

The brush polishing apparatus 30 shown in FIG. 4 is an apparatus in which a plurality of glass sheets 10 (for example, 200 sheets) are laminated to constitute a laminated body 20, and the outer peripheral portion of the laminated body 20 is polished by a rotary polishing brush 34 to collectively polish the end surface 10C of the individual glass sheets 10. When constituting the laminated body 20, the glass sheets 10 are laminated with a spacing adjusting member 22 interposed therebetween, and a spacing G in a lamination direction is adjusted to a predetermined value.

The brush polishing apparatus 30 includes a laminated body-retaining unit 32, a polishing brush 34, a drive unit (not shown) that drives the polishing brush 34, and a polishing solution supply unit 36 that supplies a polishing solution 38.

The laminated body retaining unit 32 retains the laminated body 20 in a detachable manner. In the example shown in FIG. 4, the laminated body retaining unit 32 retains the laminated body 20 from both sides in a lamination direction.

The polishing brush 34 is constructed of a shaft 34A and a plurality of brush bristles 34B that are radially provided on the outer periphery of the shaft 34A. The shaft 34A is formed in a cylindrical shape having a predetermined outer diameter. The brush bristles 34B are provided on the outer periphery of the shaft 34A by winding a strip-shaped body on which the brush bristles 34B are inserted, around the outer periphery of the shaft 34A in a spiral manner. For example, the brush bristles 34B are constructed of a flexible wire material composed of a polyamide resin and the like. The wire material may contain particles such as alumina (Al₂O₃), silicon carbide (SiC), and diamond.

The polishing solution supply unit 36 supplies the polishing solution to a contact portion between the polishing brush 34 and the laminated body 20. The polishing solution 38 contains a polishing agent and a dispersion medium and is adjusted to have a predetermined specific gravity. As the polishing agent, for example, cerium oxide, zirconium oxide, and the like are used. For example, an average particle size (D50) of the polishing agent is 5 μm or less, and preferably 2 μm or less. The specific gravity of the polishing solution is preferably set to 1.1 to 1.4.

Next, operation of the brush polishing apparatus 30 will be described.

First, the polishing brush 34 is rotated at a constant rotational speed.

Next, the polishing brush 34 is horizontally moved toward the laminated body 20, and the polishing brush 34 is compressed against and brought into contact with the outer periphery of the laminated body 20. At this time, the polishing brush 34 is horizontally moved in order for the brush to come into contact with the laminated body in a predetermined pushed-in amount.

Next, the polishing solution is supplied to the contact portion between the polishing brush 34 and the laminated body 20 in a predetermined supply amount from the polishing solution supply unit 36.

Next, the polishing brush 34 is reciprocally moved in an axial direction (a lamination direction of the glass sheets 10) at a predetermined speed. According to this, the end surface 10C of the plurality of glass sheets 10 can be collectively polished, thereby obtaining the glass sheets 10 in which the arithmetic average roughness Ra of the end surface 10C is 20 nm or less.

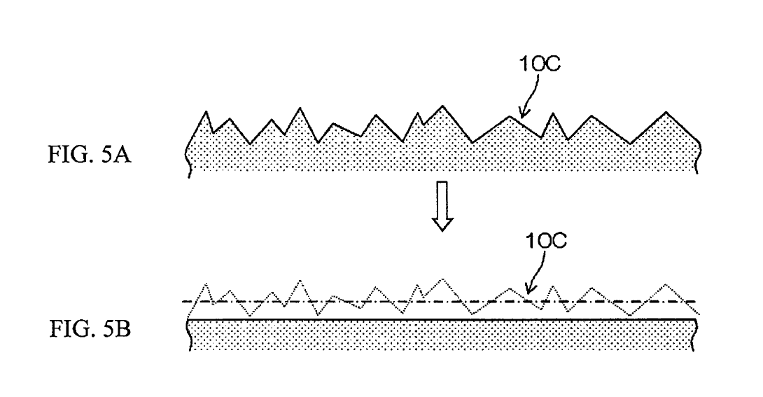

FIG. 5A is a cross-sectional view of the end surface 10C, which schematically illustrates the roughness (shape) of the end surface 10C immediately after the cutting. FIG. 5B is a cross-sectional view of the end surface 10C, which schematically illustrates the roughness (shape) of the end surface 10C after the polishing treatment.

As shown in FIGS. 5A and 5B, the concavo-convex portion of the flaws on the end surface 10C of the glass sheets 10 is polished and removed by the polishing brush 34, whereby the arithmetic average roughness Ra of the end surface 10C becomes 20 nm or less. As a result, the edge strength is enhanced.

As described above, when the etching treatment or the polishing treatment is performed with respect to the end surface 10C of the glass sheet 10, the strength of the end surface 10C is enhanced,

Next, a treatment of applying the protective layer 40 to the end surface 10C of the glass sheet 10 is performed (step S6).

### (Protective Layer)

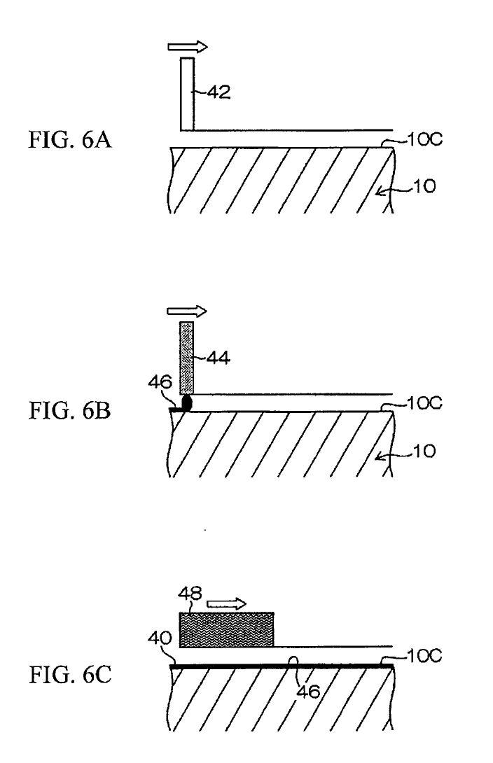

FIGS. 6A to 6C illustrate a process of applying the protective layer 40 to the end surface 10C of the glass sheet 10.

As shown in FIG. 6A, first, a laser sensor 42 is allowed to travel along the end surface 10C of the glass sheet 10 to acquire a shape and length of the end surface 10C.

Next, as shown in FIG. 6B, the distance of an application nozzle 44 from the end surface 10C is controlled on the basis of the length and shape which have been acquired by the laser sensor 42, and the application nozzle 44 is allowed to travel along the end surface 10C and, at the same time, an ultraviolet-curable resin 46 is supplied from the application nozzle 44 toward the end surface 10C. According to this, the ultraviolet-curable resin 46 which is to be the protective layer 40 is applied onto the end surface 10C.

Next, as shown in FIG. 6C, an ultraviolet-ray irradiation lamp 48 is allowed to travel along the end surface 10C to irradiate the ultraviolet-curable resin 46 with ultraviolet rays. According to this, the ultraviolet-curable resin 46 is cured, whereby the protective layer 40 is provided to the end surface 10C.

In addition, the protective layer 40 is an ultraviolet-cured resin that is a photo-cured resin, but a heat-cured resin may also be employed.

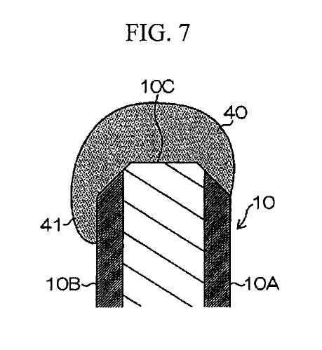

In addition, a cross-sectional shape of the protective layer 40 may be a semi-circular shape as shown in FIG. 7.

### (Characteristics and Effect of Touch Sensor Integrated-Type Cover Glass of Embodiment)

### [Effect by Etching Treatment and Protective Layer]

In the end surface 10C of the glass sheet 10 of the touch sensor integrated-type cover glass 1, the arithmetic average roughness Ra of the end surface 10C is reduced to 3 μm or less by the etching treatment as a first step, whereby the strength of the end surface 10C itself of the glass sheet 10 is enhanced. In addition, as a second step, the protective layer 40 is formed on the end surface 10C in which the edge strength is enhanced. According to this, the end surface 10C of the glass sheet 10 of this embodiment is protected by the protective layer 40, whereby the abraded edge strength is further enhanced.

As a result, according to the glass sheet 10 of this embodiment, it is possible to provide a strengthened glass article having enhanced abraded edge strength in the glass sheet 10 in which a tensile stress layer is exposed on the end surface 10C.

### [Effect by Polishing Treatment and Protective Layer]

In the end surface 10C of the glass sheet 10 of the touch sensor integrated-type cover glass 1, the arithmetic average roughness Ra of the end surface 10C is reduced to 20 nm or less by the polishing treatment as a first step, whereby the strength of the end surface 10C itself of the glass sheet 10 is enhanced. In addition, as a second step, the protective layer 40 is formed on the end surface 10C in which the edge strength is enhanced. According to this, the end surface 10C of the glass sheet 10 of this embodiment is protected by the protective layer 40, whereby the abraded edge strength is further enhanced.

As a result, according to the glass sheet 10 of this embodiment, it is possible to provide a strengthened glass article having enhanced abraded edge strength in the glass sheet 10 in which a tensile stress layer is exposed on the end surface 10C.

### [Other Effects]

As shown in FIG. 1, when the maximum thickness of the protective layer 40 is set to T₁, and the thickness of the glass sheet 10 is set to T₀, it is preferable that T₁ satisfies 50 μm<T₁≦2T₀.

In an abrasion durability test of the protective layer 40 which is performed under predetermined conditions, when the maximum thickness T₁ of the protective layer 40 is 50 μm or less, it is difficult to obtain sufficient durability because the thickness of the protective layer 40 is small. On the other hand, when the T₁ exceeds 2T₀, the dimensional accuracy of the glass sheet 10 including the protective layer 40 decreases, and thus this is not preferable. In addition, during handling of the glass sheet 10, a bending moment that occurs at a boundary portion between the end surface 10C of the glass sheet 10 and the protective layer 40 increases, whereby the protective layer 40 tends to be detached from the end surface 10C. In addition, when the thickness T₀ of the glass sheet 10 satisfies 0.5 mm≦T₀≦1.1 mm, the maximum thickness T₁ of the protective layer 40 satisfies 50 μm<T₁≦2200 μm. However, in consideration of application efficiency of the protective layer 40, the maximum thickness T₁ of the protective layer 40 is preferably set to approximately 400 μm to 1000 μm.

On the other hand, it is preferable that a thickness T₂ of the protective layer 40 at a boundary position C between the compressive stress layer A and the tensile stress layer B of the glass sheet 10 is 30 μm or more.

The depth of the flaws, which are generated in an abrasion strength test to be described later, in a thickness direction of the protective layer 40, is less than 30 μm. Therefore, when the thickness T₂ is set to 30 μm or more, it is possible to prevent the flaws from reaching the end surface 10C of the glass sheet 10, thereby retaining the durability.

In addition, it is preferable that the protective layer 40 includes an extending portion 41 extending to at least one main surface between the first main surface 10A and the second main surface 10B.

When the extending portion 41 is provided to the protective layer 40, it is possible to enhance the abraded edge strength of the edge portion of the glass sheet 10.

The extending portion 41 may be provided on both of the first main surface 10A and the second main surface 10B. However, in the case where the glass sheet 10 is a strengthened glass sheet that is used in the touch sensor integrated-type cover glass 1 as shown in FIGS. 1 and 7, it is preferable that the extending portion 41 is not provided on to the first main surface 10A that is a touch surface. The reason is that the extending portion 41 is exposed to the outside, whereby the external appearance of the touch sensor integrated-type cover glass 1 becomes deteriorated.

It is preferable that the length X of the extending portion 41 satisfies 10 μm≦X≦200 μm.

In addition, the length X is a length from a boundary of the end surface 10C and the second main surface 10B of the glass sheet 10 to an in-plane portion of the second main surface 10B.

When a value of the length X is 10 μm or more, it is possible to prevent the abraded edge strength from decreasing, and adhesion between the strengthened glass sheet and the protective layer is enhanced due to an increase in the contact area therebetween. In addition, when the value of the X is 200 μm or less, deterioration of the external appearance is not caused, and the extending portion does not hinder the application of a protective film in a subsequent process.

It is preferable that the thickness Y of the extending portion 41 satisfies 10 μm≦Y≦100 μm.

The thickness Y represents a thickness in a direction perpendicular to the second main surface 10B of the glass sheet 10. According to this, the abraded edge strength against a force applied from an inclined direction with respect to a direction perpendicular to the end surface 10C is enhanced.

When a value of Y is 10 μm or more, it is possible to prevent the abraded edge strength from decreasing. In addition, when the Y is 100 μm or less, deterioration of the external appearance is not caused, and the extending portion does not hinder the application of the protective film in a subsequent process.

Hereinafter, the abraded edge strength of the strengthened glass article of the embodiment will be described with reference to examples. In addition, examples 1 to 4 to be described later are Comparative Examples, and examples 5 to 7 to be described later are Examples.

### (Glass Sheet)

Test specimens having dimensions of 50 mm×100 mm and a thickness of 0.8 mm were prepared by using an alkali aluminosilicate glass composed of SiO₂: 64.2 mol %, Al₂O₃: 8.0 mol %, MgO: 10.5 mol %, CaO: 0.1 mol %, SrO: 0.1 mol %, BaO: 0.1 mol %, Na₂O: 12.5 mol %, K₂O: 4.0 mol %, and ZrO₂: 0.5 mol %.

### (Strengthening of Glass Sheet)

The entirety of the glass sheets (test specimens) of examples 1 to 7 were subjected to chemical strengthening by performing ion exchanging in molten salt of KNO₃ at 410° C. for one hour, to achieve a compressive stress value CS at a surface layer: 700 MPa, a depth DOL of a compressive stress layer: 18 μm, and an internal tensile stress value CT: 16 MPa.

### (Cutting of Strengthened Glass Sheet)

The strengthened glass sheets of examples 1, 2, and 4 to 6 to which the chemical strengthening was performed were cut by using a wheel cutter, and the strengthened glass sheets of examples 3 and 7 were cut by using a CO₂ laser.

### (Chamfering)

The end surfaces of the strengthened glass sheets of examples 1, 2, and 4 to 6 were ground by a depth of 0.2 mm by using a computer numerical control (CNC) chamfering apparatus provided with a grindstone of a count #600.

### (Etching of End Surface)

The end surface of the strengthened glass sheet of example 1 was etched by a depth of 5 μm. As an etching solution, a mixed solution of hydrofluoric acid and hydrochloric acid was used.

### (Brush Polishing of End Surface)

The strengthened glass sheets of examples 2, and 4 to 6 were polished by a depth of 0.1 mm by being brought into contact with a rotary brush while supplying a polishing solution, which contains abrasive grains. As the abrasive grains, cerium oxide particles were used.

### (Application of Protective Layer)

An ultraviolet-curable resin (a photo-sensitive resin, trade name: Photolec, manufactured by Sekisui Chemical Co., Ltd.) was ejected from an application nozzle in a desired quantity to the end surface of the strengthened glass sheets of examples 4 to 7, and was cured by irradiation of ultraviolet rays, thereby forming a protective layer to obtain strengthened glass articles.

The strengthened glass articles of examples 4 and 5 were made to have a form in which extending portion was not present, and the strengthened glass articles of examples 6 and 7 were made to have a form in which an extending portion was present.

### (Abrasion of End Surface of Strengthened Glass Article)

A #400 water-resistant paper (manufactured by RIKEN CORUNDUM CO., LTD.) was mounted to a load variable type friction and abrasion system (HHS2000: manufactured by Shinto Scientific Co., Ltd.), the water-resistant paper was pressed against the protective layers of the strengthened glass articles of examples 1 to 7 at a load of 120 gf (1.2 N) at an angle of 20° with respect to the first main surface 10A or the second main surface 10B, and abrasion was performed once at a speed of 20 mm/second along the end surface 10C, thereby abrading the end surfaces of the strengthened glass sheets of examples 1 to 3 and the surface of the protective layers of the strengthened glass articles of examples 4 to 7.

### (Measurement of Abraded Edge Strength of Strengthened Glass Article)

Average four-point bending strength was measured with respect to the strengthened glass articles of examples 1 to 7 according to a method defined in HS R1601 (enacted in 2008).

TABLE 1

| | Example 1 | Example 2 | Example 3 | Example 4 | Example 5 | Example 6 | Example 7 |
|---|---|---|---|---|---|---|---|
| End surface Ra | 1 μm | 0.02 μm | 0.02 μm | 0.02 μm | 0.02 μm | 0.02 μm | 0.02 μm |
| T₁ | Protective layer | Protective layer | Protective layer | 30 μm | 450 μm | 300 μm | 450 μm |
| | is not present | is not present | is not present | | | | |
| T₂ | Protective layer | Protective layer | Protective layer | 10 μm | 200 μm | 100 μm | 200 μm |
| | is not present | is not present | is not present | | | | |
| Extending | | | | Not present | Not present | Present | Not present |
| portion | | | | | | X: 0.07 mm | |
| | | | | | | Y: 0.05 mm | |
| Edge strength | 830 MPa | 900 MPa | 780 MPa | 900 MPa | 900 MPa | 900 MPa | 780 MPa |
| before abrasion | | | | | | | |
| Abraded edge | 160 MPa | 300 MPa | 400 MPa | 300 MPa | 720 MPa | 810 MPa | 770 MPa |
| strength | | | | | | | |
| Strength | 81% | 67% | 49% | 67% | 20% | 10% | 1% |
| decrease rate | | | | | | | |

In the strengthened glass sheets of examples 1 to 3 which were not provided with a protective layer, and the strengthened glass article of example 4 in which the maximum thickness of the protective layer was 50 μm or less, the edge strength (abraded edge strength) after the abrasion significantly decreased in comparison to the edge strength before the abrasion.

In contrast, the end surface of the strengthened glass articles of examples 5 to 7 were protected by the protective layer, and thus flaws did not reach the strengthened glass sheets even when the end surface of the strengthened glass articles was abraded. Accordingly, a decrease in the edge strength could be suppressed.

In addition, in the embodiment, an example in which the strengthened glass article was applied to the glass sheet 10 of the touch sensor integrated-type cover glass 1 was described, but the use of the strengthened glass article of the invention is not limited to the glass sheet 10 of the touch sensor integrated-type cover glass 1.

Obviously, numerous modifications and variations of the present invention are possible in light of the above teachings. It is therefore to be understood that within the scope of the appended claims, the invention may be practiced otherwise than as specifically described herein.

### DESCRIPTION OF REFERENCE NUMERALS AND SIGNS

1: Touch sensor integrated-type cover glass
10: Glass sheet (strengthened glass sheet)
10A: First main surface
10B: Second main surface
10C: End surface
11: Chamfered surface
12: Input position-detecting electrode
14: Light-shielding layer
16: Peripheral interconnection
18: Protective film
20: Laminated body
22: Spacing adjusting member
30: Brush polishing apparatus
32: Laminated body retaining unit
34: Polishing brush
36: Polishing solution supply unit
38: Polishing solution
40: Protective layer
42: Laser sensor
44: Application nozzle
46: Ultraviolet-curable resin
48: Ultraviolet-ray irradiation lamp

1. A strengthened glass article, comprising a glass sheet having:
a first main surface;
a second main surface that is opposite to the first main surface; and
an end surface that connects the first main surface and the second main surface,
wherein the glass sheet is a strengthened glass sheet which comprises a compressive stress layer on each surface of the first main surface and the second main surface and a tensile stress layer on the end surface,
wherein the end surface of the strengthened glass sheet has an arithmetic average roughness Ra, satisfying Ra≦3 μm, and the end surface is provided with a protective layer, and
wherein the protective layer has a maximum thickness T₁ and the strengthened glass sheet has a thickness T₀, satisfying 50 μm<T₁≦2T₀.

2. The strengthened glass article according to claim 1,
wherein the arithmetic average roughness Ra of the end surface of the strengthened glass sheet satisfies Ra≦20 nm.

3. The strengthened glass article according to claim 1,
wherein the protective layer has a thickness T₂ at a boundary position between the compressive stress layer and the tensile stress layer of the strengthened glass sheet, satisfying T₂≧30 μm.

4. The strengthened glass article according to claim 1,
wherein the protective layer includes an extending portion extending to at least one main surface of the first main surface and the second main surface.

5. The strengthened glass article according to claim 4,
wherein the extending portion has a length X of from a boundary of the end surface and the main surface of the strengthened glass sheet toward an in-plane portion of the main surface, satisfying 10 μm≦X≦200 μm.

6. The strengthened glass article according to claim 4,
wherein the extending portion has a thickness Y in a direction perpendicular to the main surface of the strengthened glass sheet, satisfying 10 μm≦Y≦100 μm.

7. The strengthened glass article according to claim 1,
wherein the protective layer is a photo-cured resin or a heat-cured resin.

8. The strengthened glass article according to claim 7,
wherein the protective layer is an ultraviolet-cured resin.

9. A touch sensor integrated-type cover glass, comprising the strengthened glass article described in claim 1.
